(19) United States
(12) Patent Application Publication
(10) Pub. No.: US 2021/0164394 A1
(43) Pub. Date: Jun. 3, 2021

(54) Zero Stroke Thrust Vectoring Ignition Chamber Engine

(71) Applicant: Ravi Shankar Gautam, Gaya (IN)

(72) Inventor: Ravi Shankar Gautam, Gaya (IN)

(21) Appl. No.: 17/262,725

(22) PCT Filed: Jul. 25, 2019
(86) PCT No.: PCT/IN2019/050545

§ 371 Date: Jan. 24, 2021

(30) Foreign Application Priority Data
Jul. 25, 2018 (IN) 201821027868

(51) Int. Cl. F02C 5/02; F02B 75/32; F01C 11/00

(52) U.S. Cl. CPC F02C 5/02; F01C 11/002; F02B 75/32

(57) ABSTRACT

This patent discloses thrust vectoring ignition chamber engine. Thrust vectoring ignition chamber used in this engine is an annular cylinder having nozzles mounted in a way such that during fuel suction phase they are sealed and during ignition of fuel they are unsealed so that hot jets of ignited fuel escaping through nozzles cause coupled rotatory motion on the ignition chamber. Engine uses cam operated suitably modified 3-screw compressor for suction and compression of fuel and therefore do not require piston mechanism. Flywheel mounted on extension of ignition chamber functions as output of the engine. Each half rotation of flywheel completes three phases namely fuel/air suction, compression and combustion. Thus this engine fires for every half revolution and therefore can give improved power boost.

### FIELD OF THE INVENTION

The present disclosure relates generally to engine which can use petrol, diesel, compressed natural gas etc as fuel.

### BACKGROUND OF THE INVENTION

To be able to distinguish humans from trees mobility plays a key role. Automobile have played significant role in enhancing human civilization by transporting agricultural products, construction material to build better homes etc. There has been lot of effort in improving various parts of the engine in order to increase its fuel efficiency. This invention is an effort in this direction.

In automobile engines we need output which can rotate wheels. All automobile engines consist of cylindrical ignition chamber in which a piston is slip fit and is allowed to move back and forth at cylinder's rear end. Fuel-air mixture that ignition chamber received from an inlet valve (located at front end) is compressed and ignited to cause sudden expansion of gas which in turn causes thrust to the piston forcing in move rearwards. Connecting rods connecting the piston to crank shaft helps to convert translation motion of piston to rotatory motion of crankshaft which in turn causes flywheel (that is axially attached to crankshaft) to rotate. Flywheel causes wheel of automobile to rotate via transmission mechanism. One cycle of a four stroke engine for generating thrust from fuel consists of four phases namely fuel-air mixture suction, fuel-air mixture compression, ignition via spark plug (that causes thrust) and exhaust of burnt gas through exhaust valve located on the front end of ignition chamber. Each phase requires one strokes of piston and hence one cycle involves two rotations of crankshaft and therefore flywheel.

### Disadvantages in the Prior Art

One of the drawbacks of four stroke engine is one phase of exhaust of burnt fuel gas is unproductive.

One of the drawbacks of four stroke engine is that it requires conversion of translation motion to rotatory motion for compression of fuel-air mixture as well as rotation of crankshaft.

One of the drawbacks of four stroke engine is that moving parts like inlet valves and exhaust valve comes in contact with ignited fuel gas mixture due to which it requires overhaul and maintenance. For example unmaintained valves may cause fuel backfire etc.

One of the drawbacks of four stroke engine is that it requires complex process and lot of moving parts to operate cam mechanisms for operating inlet and exhaust valves.

One of the drawbacks of two stroke engine is that exhaust gas and fuel gets mixed which causes lot of pollution.

### SUMMARY

One of the objectives is to provide an engine which can directly convert fuel thrust to rotatory motion. This is achieved by thrust vectored exit of ignited fuel-air mixture. Ignited fuel-air mixture is bound to escape through pair of angled nozzles located at diametrically opposite sides of ignition chamber. Nozzles are angled with each nozzle making an acute angle with respect to outward radial direction. Difference between angles that nozzles make with the line joining them is 180 degree so that the exhaust of gas cause coupled torque on the ignition chamber.

Engine, according to this invention, do not use piston based compression mechanism.

In the engine, according to this invention, each half rotation of flywheel completes three phases namely fuel/air suction, compression and combustion, instead of two rotations as required in engine according to prior art. Thus this engine improves power boost.

Engine, according to this invention, do not require a separate phase for exhaust of burnt gas and do not cause mixing of exhaust gas with fuel as well.

In the engine, according to this invention, ignition chamber directly operates the cam mechanism without involving large number of moving parts.

Engine, according to this invention, uses cam operated suitably modified 3-screw compressor for suction and compression of fuel and therefore do not require piston mechanism.

### BRIEF DESCRIPTION OF THE DRAWINGS

FIG. 1 Side view of zero stroke thrust vectoring ignition chamber engine with engine support mechanism according to this invention

FIG. 2 Rear view of thrust vectoring ignition chamber of the engine according to this invention

FIG. 3 to FIG. 8 Fuel supply system of the engine illustrating modified 3-screw compressor

FIG. 9 Top view of rotors of modified 3-screw compressor

FIG. 10 Variation of zero stroke thrust vectoring ignition chamber engine with electrically control mechanism for nozzle seal with nozzle seal shown to be in closed state.

FIG. 11 and FIG. 12 Rear and side view of thrust vectoring ignition chamber of the engine with electrically control mechanism for nozzle seal with nozzle seal shown to be in open state.

### DETAILED DESCRIPTION OF THE PREFERRED EMBODIMENT

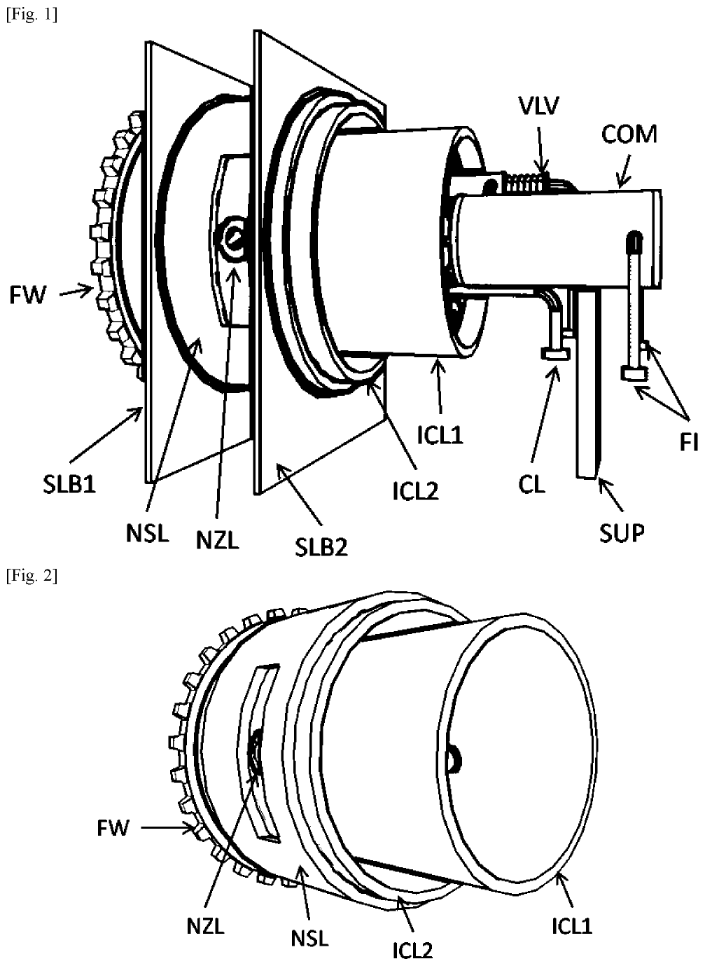

Referring to FIG. 1, the preferred embodiment of an zero stroke automobile engine (1) according to this invention is shown to include an engine enclosure (ENC), thrust vectoring ignition chamber (IC), fuel supply system (FSS), nozzle seal (NSL), and flywheel (FW).

Engine enclosure (ENC), as shown in FIG. 1, appropriately secures all parts of engine, provides support to engine via rectangular slabs (SLB1), (SLB1) and (SUP) attached to outer static parts of engine like nozzle seal and 3-screw compressor and provides exit to the burnt fuel gas via exhaust pipe.

Thrust vectoring ignition chamber (IC), as shown in FIG. 2, consists of a pair of coaxial annular cylinders, an inner annular cylinder (ICL1) and an outer annular cylinder (ICL2), connected coaxially via coaxial rings (IR), and coupled thrust vectoring nozzle (NZL) wherein inner annular cylinder (ICL1) is coaxially fixedly caped at front side by ignition chamber seal (ICS), which is a circular disk;
fuel supply system (FSC) is mounted on rear side of the ignition chamber;
coupled thrust vectoring nozzle (NZL) is a pair of conical tubes mounted at diametrically opposite points on the right circular section on the middle part of ignition chamber by passing through holes on the inner annular cylinder (ICL1) and outer annular cylinder (ICL2) such that one end with bigger aperture opens inside the inner annular cylinder (ICL1) and other end with smaller aperture opens on the outer side of outer annular cylinder (ICL2);
each tube make equal acute angle with respect to radially outward direction in opposite direction along the right circular section of ignition chamber;
surface of the nozzles on the outer side of ignition chamber are cut to take the shape of outer surface of the outer annular cylinder (ICL2) so that ignition chamber can glide inside the nozzle seal cylinder smoothly and surface of the nozzles on the inner side of ignition chamber are cut to take the shape of inner surface of the inner annular cylinder (ICL1);

ignition chamber (IC) extends towards rear side of the nozzle wherein its inner annular cylinder (ICL1) extends longer than the outer annular cylinder (ICL2) towards the rear side.

Nozzle seal (NSL), used to seal and unseal nozzle (NZL), as shown in FIG. 2, is an annular cylinder which holds outer annular cylinder (ICL2) of the ignition chamber via ball bearing such that
its middle portion falls above the nozzle (NZL);
its length is such that outer annular cylinder (ICL2) is exposed on its rear and front side;
its middle portion has two rectangular holes at diametrically opposite sides, with length of each hole is such that they subtend an angle of 60 degree (may be calibrated according to the requirement) at the center of the circle and width little greater than the diameter of the outer aperture of nozzles;
thrust vectoring nozzle (NZL) remain sealed except when passes under gas exiting holes of nozzle seal (NSL).

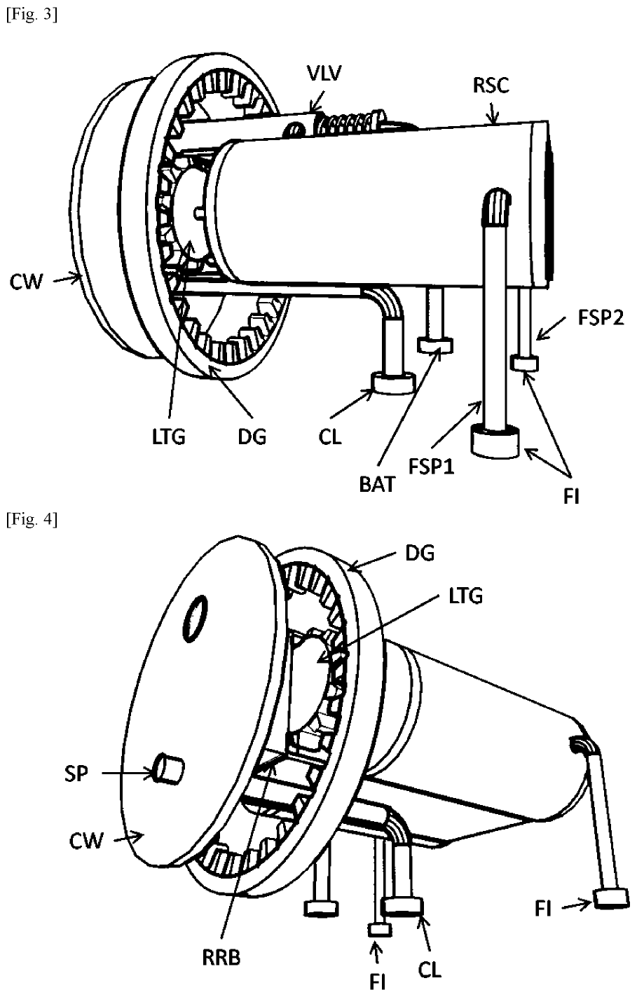

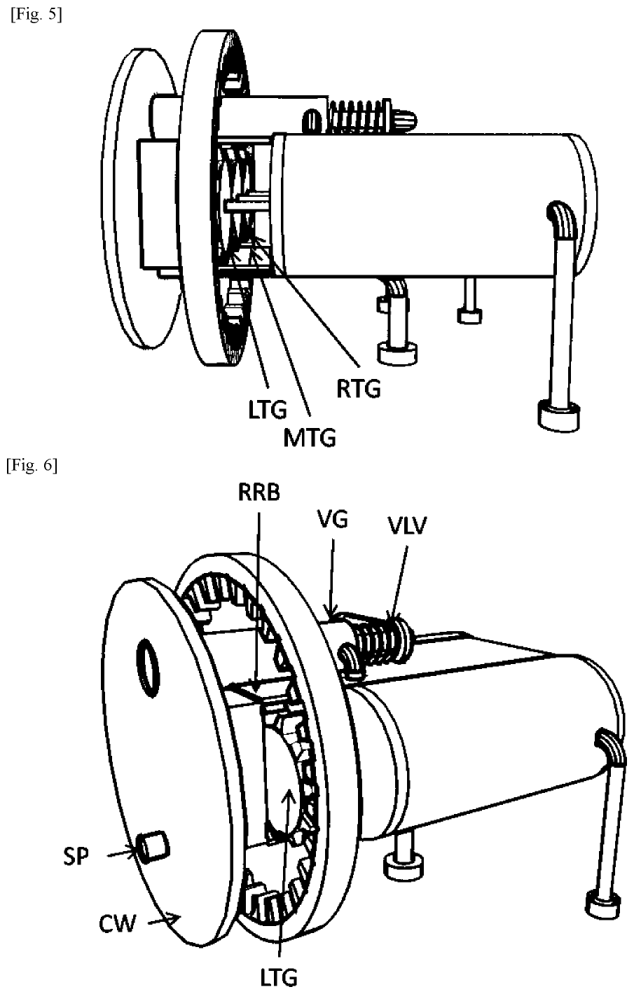

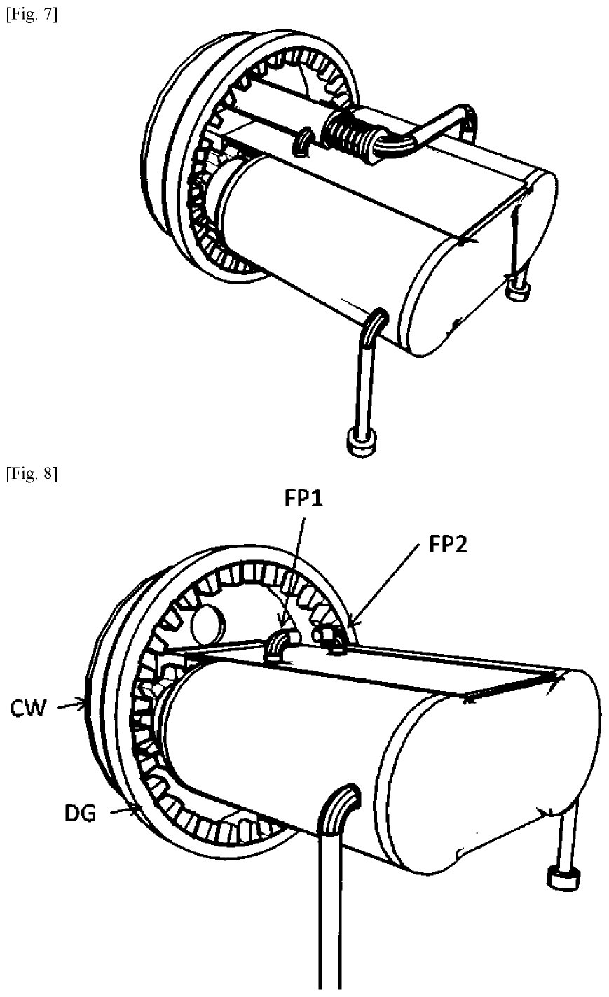

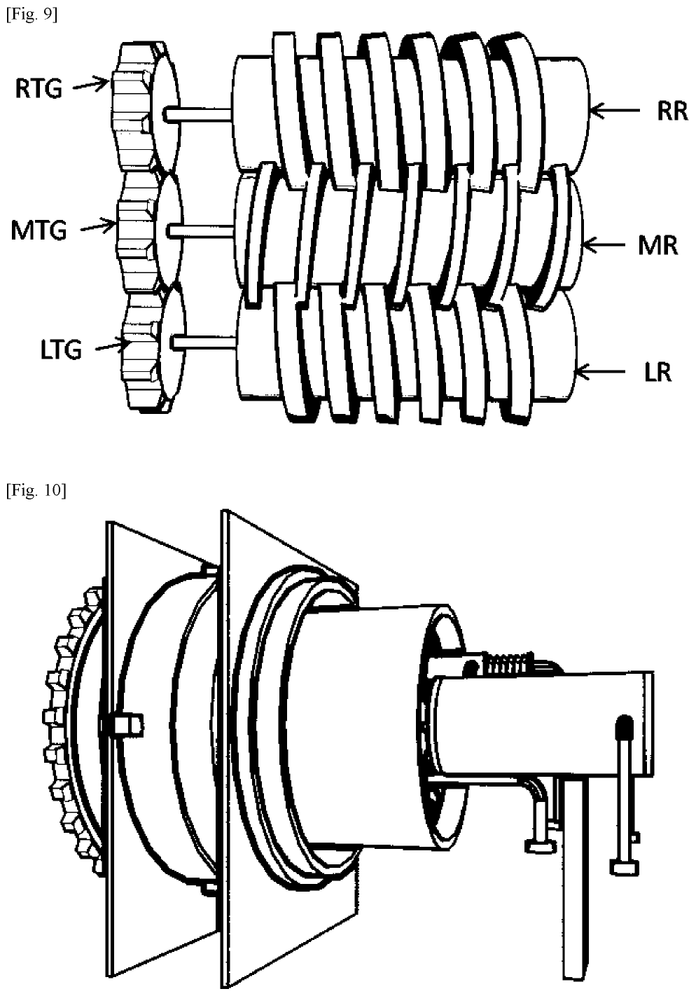

Fuel supply system (FSS), as shown in FIGS. 3 to 9, which is designed to suck fuel-air mixture and transmit it to the ignition chamber in the compressed form, consists of fuel compression mechanism (FCM), fuel suction mechanism (FSM), fuel delivery and ignition mechanism (FDI).

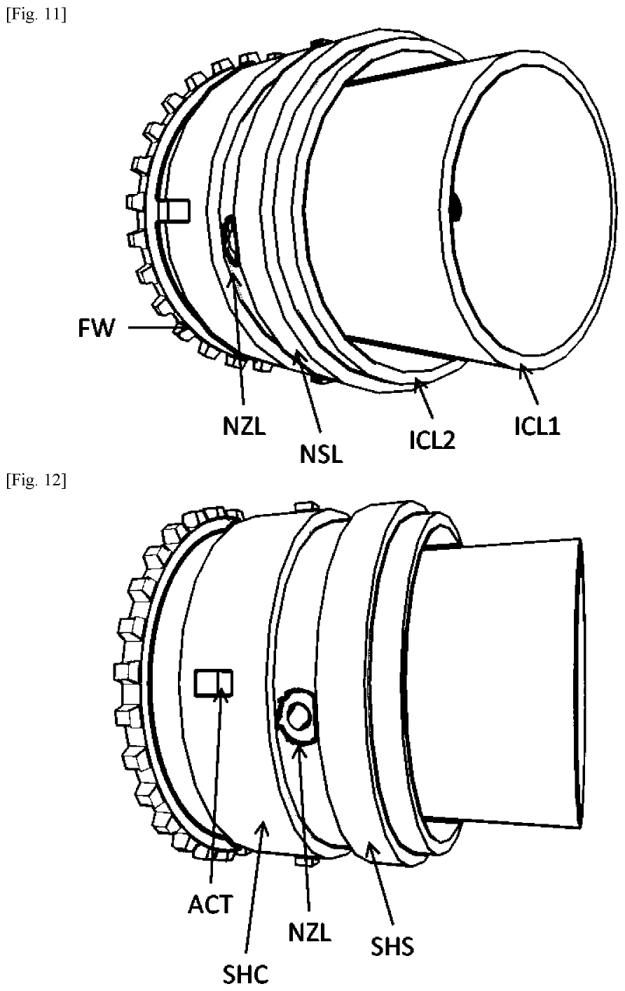

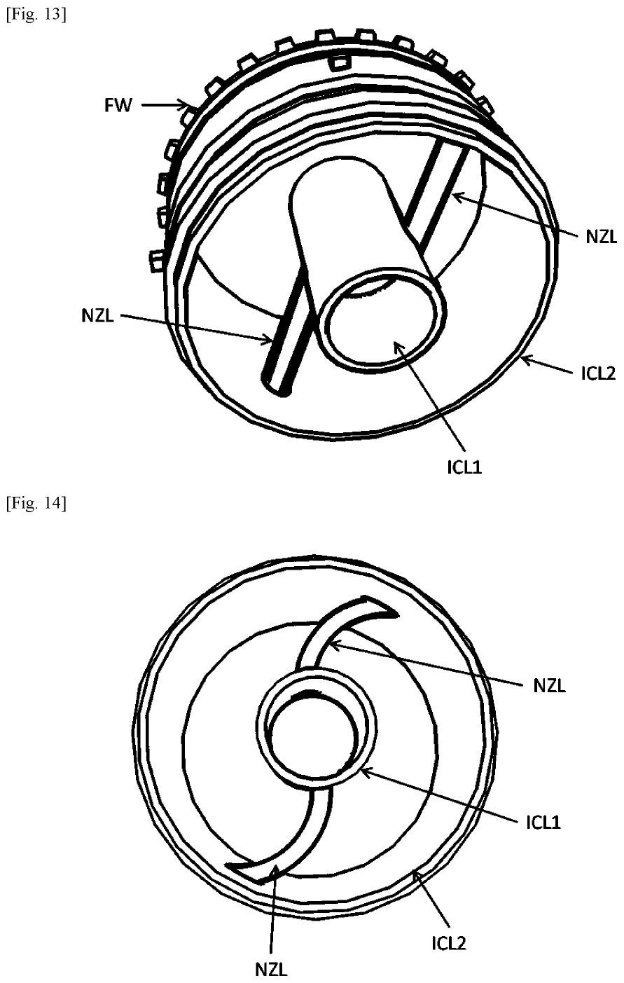

Fuel compression mechanism (FCM), as shown in FIGS. 3 to 9, consists of suitably modified 3-screw compressor (COM), rotor reinforcement bracket, (RRB), screw compressor support (SUP) wherein
modified 3-screw compressor (COM), as shown in FIG. 9, has three screw rotors, namely left rotor (LR), middle rotor (MR) and right rotor (RR), encased in rotor seal casing (RSC) with left rotor (LR) and right rotor (RR) being male screw rotors have grooves of same orientation and opposite to that of middle rotor (MR) which is a female screw rotor and three rotors arranged such that grooves of left rotor (LR) and right rotor (RR) are meshingly engaged with the groove of middle rotor (MR) on its left and right side respectively;
three rotor timing gears, left timing gear (LTG), middle timing gear (MTG) and right timing gear (RTG), lying outside the rotor seal casing (RSC) are coaxially mounted to the front side of drive shafts of left rotor (LR), middle rotor (MR) and right rotor (RR) respectively;
rotor seal casing (RSC) has two holes on its rear part, one on the left side of left rotor (LR) and one on the right side of right rotor (RR) and has two holes on its front part, one on the left upper side and one on the right upper side of middle rotor (MR) wherein holes at the front part work as fuel discharge ports and holes in the rear part work as fuel intake nozzles;
rotor reinforcement bracket (RRB), as shown in FIGS. 4 and 6, is a C-shaped brackets, on the front side of rotor seal casing (RSC) such that upper arm and lower arm of bracket connected to the upper and lower edges of front side of rotor seal casing and axis of rotors extending beyond timing gears are connected to the inner side of the middle arm of the brackets;
left timing gear (LTG), right timing gear (RTG), as shown in FIG. 4, are exposed on the outward side of the bracket;
screw compressor support (SUP) is a vertical metal plate which is connected at its upper part to the outer side of the lower surface of the rotor seal casing and attached at its lower end to engine enclosure (ENC) to provide support to and fix the position of the screw compressor.

Note that modified 3-screw compressor (COM) mentioned above is a conventional 3-screw compressor with modification that drive shafts of all the three rotors extends out of rotor seal casing from the side of fuel discharge port instead of the side of fuel intake nozzles and timing gears mounted of drive shafts lie outside the rotor seal casing.

Fuel suction mechanism, (FSM), consists of a drive gear (DG) a pair of fuel supply pipes, namely left fuel supply pipe (FSP1) and right fuel supply pipe (FSP2), fuel injector wherein
drive gear (DG), as shown in FIG. 3, being internally toothed circular annular gears, are coaxially attached to the rearward extension of the inner annular cylinder of ignition chamber near front end of rotor seal casing (RSC), so that drive gear (DG) meshes with the exposed part of the left timing gear (LTG) and right timing gear (RTG);
left fuel supply pipe (FSP1) and right fuel supply pipe (FSP2), as shown in FIG. 3, are cylindrical pipes whose front side apertures are sealingly attached to the fuel suction nozzles on the left and right side, respectively, on the rear end of the rotor seal casing and both pipes are connected at their rear ends to fuel injector (FI).

Note that there is an empty region between the outer side of rotor seal casing and inner side of the rearward extension of the inner annular cylinder (and therefore between drive gear and timing gears). Distance between the upper most point of the inner annular cylinder and upper side of the rotor seal casing is around the diameter of the rotor similarly on the lower side distance between the lower most point of the inner annular cylinder and lower side of the rotor seal casing is around the diameter of the rotor.

Fuel delivery and ignition mechanism, (FDI), consists of a pair of fuel ports namely, left fuel port (FP1) and right fuel port (FP2), a solenoid coil operated fuel-air inlet valve, (VLV), a spark-plug, electrical control mechanism, combustion wall (CW), valve gaskets (VG) wherein
combustion wall (CW), as shown in FIG. 6, is a circular disk coaxially slip fit into inner annular cylinder of ignition chamber located close to and rear side of nozzles and is attached at its rear side to the outer side of the middle arm of front rotor reinforcement bracket (RRB);
combustion wall (CW), as shown in FIG. 6, has one hole on the upper part and one on the lower part;
left fuel port (FP1) and right fuel port (FP2), as shown in FIG. 8, are narrow arc-shaped cylindrical pipes which are sealingly attached at their lower aperture to discharge ports on the upper side on the front part of rotor seal casing and upper aperture opens inside the fuel valve (VLV) to work as fuel port for the ignition chamber;
valve gasket (VG), as shown in FIG. 6, is an horizontal cylinders located on front part of the outer side of the rotor seal casing, with their front aperture sealingly attached to holes on upper part of the combustion wall (CW);
fuel valve (VLV), as shown in FIG. 6, is a push to open valve operated by solenoid coils mounted on the valve gasket (VG) so that upper hole in the combust wall works as valve seat;
solenoid coils on rear side of fuel valve is connected to battery;
spark plug (SP), as shown in FIG. 6, is mounted horizontally on the lower side of front part of rotor seal casing and opens inside the ignition chamber through a hole on upper part of the combustion wall so that its electrode is exposed towards the nozzle in the ignition chamber;
spark plug at its rear side is connected to ignition coil (CL).

Flywheel (FW), as shown in FIG. 1, an externally teethed annular gear that functions as an output of the engine, is connected coaxially to the front side extension of outer annular cylinder (ICL2) of ignition chamber.

Thrust vectored ignition chamber engine described above is an engine which can use petrol as fuel and in order to use diesel as a fuel we need to replace spark plug with pressure valve, ignition coil with fuel source, air-fuel valve with air valve.

According to one variation to above description, nozzle seal (NSL), which dynamically puts nozzle (NZL) into closed or open phase, consists of three annular cylinders, namely shutter cavity (SHC), shutter (SH) and shutter stopper (SHS), coaxially mounted on outer side of outer cylinder of ignition chamber near nozzle (NZL) and a push-pull solenoid actuator (ACT), wherein
shutter cavity (SHC) is a special type of annular cylinder, whose front portion coaxially holds the outer annular cylinder of ignition chamber (ICL2) with the help of a ball bearing but the rear portion (which is facing nozzle) forms an annular cylindrical cavity with outer annular cylinder of ignition chamber (ICL2) which can house shutter (SH);
shutter (SH) is an annular cylinder coaxially mounted to the rear portion of the shutter cavity (SHC) such that outer annular cylinder of ignition chamber (ICL2) slip fits inside the shutter (SH) and shutter (SH) can be operated by actuator (ACT) to slide in and out of cylindrical annular cavity on the rear portion of shutter cavity (SHC) to unseal and seal the nozzles (NZL) respectively;
shutter stopper (SHS) is an annular cylinder located on the rear side of nozzles (NZL), which coaxially holds the outer annular cylinder of ignition chamber (ICL2), via one or more coaxial ball bearings and to helps to stop shutter (SH) from sliding away;
push-pull actuator (ACT) consists of three-four solenoid coils mounted on the outer side shutter cavity (SHC), which operates the shutter (SH) and works to push and pull the shutter (SH) to slide in and slide out of the cylindrical annular cavity on the rear portion of shutter cavity (SHC);
shutter cavity (SHC), and shutter stopper (SHS) are secured to enclosure (ENC) by rectangular slabs.

According to another variation to above description, thrust vectoring nozzle (NZL) consists of pair of curved conical tubes so that escape angle of gas at outer surface of outer cylinder (ICL2) of ignition chamber can be closer to tangent of circle described by nozzles with aperture of nozzles inside the inner cylinder (ICL1) of ignition chamber, is along radial direction.

### Engine Operation for Stationary Nozzle Seal:

Each half rotation of ignition chamber and therefore flywheel is completes a cycle of three phases namely suction phase, compression phase and combustion phase with suction phase and combustion phase occurring in sequential order and compression process is a continuous process.

In suction phase nozzles are in closed state, fuel valve is in open state, and compressed air-fuel mixture coming out of the outlet gasket of the screw compressor rushes into ignition chamber. In combustion phase nozzles are in open state, fuel valve is in closed state and compressed air-fuel mixture is ignited due to which hot air gushes out of the nozzles to cause coupling torque action resulting in rotatory thrust on the ignition chamber.

Rotation of annular cylinders constituting the ignition chamber, apart from causing flywheel to rotate, also causes rotation of timing gears of male rotors and (hence female rotor) via drive gears at the front and rear ends. Rotation of the rotors causes suction of air-fuel mixture at the inlet at the rear side and transmitting to fuel outlet gasket at the front end while performing the compression action.

As soon as half rotation is complete the nozzles come in closed state. A separate phase to expell burnt gas is not required.

1. A modified 3-screw compressor based rotary automobile engine, for directly converting the fuel energy to rotatory motion using thrust vectoring of ignited fuel, consisting of an engine enclosure, thrust vectoring ignition chamber, fuel supply system, nozzle seal and flywheel.

2. Engine enclosure, claimed in [claim 1], appropriately secures all parts of engine, provides support to engine via rectangular slabs attached to outer static parts of engine like nozzle seal and 3-screw compressor of fuel supply system, claimed in [claim 1], and provides exit to the burnt fuel gas via exhaust pipe.

3. Thrust vectoring ignition chamber, claimed in [claim 1], consists of a pair of coaxial annular cylinders, an inner annular cylinder and an outer annular cylinder, connected coaxially via coaxial rings, and coupled thrust vectoring nozzle wherein
inner annular cylinder is coaxially fixedly caped at its front side by ignition chamber seal which is a circular disk;
fuel suction and compression system and fuel delivery and ignition mechanism are mounted on rear side of the ignition chamber;
coupled thrust vectoring nozzle is a pair of conical tubes mounted at diametrically opposite points on the right circular section on the middle part of ignition chamber by passing through holes on the inner annular cylinder and outer annular cylinder such that one end with bigger aperture opens inside the inner annular cylinder and other end with smaller aperture opens on the outer side of outer annular cylinder;
each tube make equal acute angle with respect to radially outward direction in opposite direction along the right circular section in middle portion of ignition chamber;
surface of the nozzles on the outer side of ignition chamber are cut to take the shape of outer surface of the outer cylinder so that ignition chamber can glide inside the nozzle seal cylinder smoothly and surface of the nozzles on the inner side of ignition chamber are cut to take the shape of inner surface of the inner annular cylinder;
ignition chamber extends towards rear side of the nozzle wherein its inner annular cylinder extends longer than the outer annular cylinder towards the front side.

4. Nozzle seal, claimed in [claim 1], used to seal and unseal nozzle, is an annular cylinder which holds outer annular cylinder of the ignition chamber via ball bearing such that
its middle portion falls above the nozzle;
its length is such that outer annular cylinder is exposed on its rear and front side;
its middle portion has two rectangular holes at diametrically opposite sides, with length of each hole is such that they subtend an angle of 60 degree (may be calibrated according to the requirement) at the center of the circle and width little greater than the diameter of the outer aperture of nozzles;
above mentioned rectangular holes are such that thrust vectoring nozzle remain sealed except when highly pressurized ignited gas is scheduled to pass through it cause rotary thrust on the ignition chamber.

5. Fuel supply system, claimed in [claim 1], which is designed to suck fuel-air mixture and transmit it to the ignition chamber in the compressed form, consists of fuel compression mechanism, fuel suction mechanism, fuel delivery and ignition mechanism.

6. Fuel compression mechanism, claimed in [claim 5], consists of suitably modified 3-screw compressor, rotor reinforcement mechanisms, screw compressor support wherein
as in conventional 3-screw compressor, modified 3-screw compressor has three screw rotors, namely left rotor, middle rotor and right rotor, encased in rotor seal casing with left rotor and right rotor being male screw rotors have grooves of same orientation and opposite to that of middle rotor which is a female screw rotor and three rotors arranged such that grooves of left rotor and right rotor are meshingly engaged with the groove of middle rotor on its left and right side respectively;
three rotor timing gears, left timing gear, middle timing gear and right timing gear, lying outside the rotor seal casing are coaxially mounted to the front side of drive shafts of left rotor, middle rotor and right rotor respectively;
rotor seal casing has two holes on its rear part, one on the left side of left rotor and one on the right side of right rotor and has two holes on its front part, one on the left upper side and one on the right upper side of middle rotor wherein holes at the front part work as fuel discharge ports and holes in the rear part work as fuel intake nozzles;
rotor reinforcement mechanism, is a C-shaped brackets, on the front side of rotor seal casing such that upper arm and lower arm of bracket connected to the upper and lower edges of front side of rotor seal casing and axis of rotors extending beyond timing gears are connected to the inner side of the middle arm of the brackets;
left timing gear, right timing gear, are exposed on the outward side of the bracket;
screw compressor support is a vertical metal plate which is connected at its upper part to the outer side of the lower surface of the rotor seal casing and attached at its lower end to engine enclosure to provide support to and fix the position of the screw compressor.

7. Fuel suction mechanism, claimed in [claim 5], consists of a drive gear a pair of fuel supply pipes, namely left fuel supply pipe and right fuel supply pipe, fuel injector wherein
drive gear being internally toothed circular annular gears, are coaxially attached to the rearward extension of the inner annular cylinder of ignition chamber near front end of rotor seal casing, so that drive gear meshes with the exposed part of the left timing gear and right timing gear;
left fuel supply pipe and right fuel supply pipe are cylindrical pipes whose front side apertures are sealingly attached to the fuel suction nozzles on the left and right side, respectively, on the rear end of the rotor seal casing and both pipes are connected at their rear ends to fuel injector.

8. Fuel delivery and ignition mechanism, claimed in [claim 5], consists of a pair of fuel ports namely, left fuel port and right fuel port, a solenoid coil operated fuel-air inlet valve, a spark-plug, electrical control mechanism, combustion wall, valve gaskets wherein
combustion wall is a circular disk coaxially slip fit into inner annular cylinder of ignition chamber located close to and rear side of nozzles and is attached at its rear side to the outer side of the middle arm of front rotor reinforcement bracket;
combustion wall has one hole on the upper part and one on the lower part;
left fuel port and right fuel port are narrow arc-shaped cylindrical pipes which are sealingly attached at their lower aperture to discharge ports on the upper side on the front part of rotor seal casing and upper aperture opens inside the fuel valve to work as fuel port for the ignition chamber;
valve gasket is an horizontal cylinders located on front part of the outer side of the rotor seal casing, with their front aperture sealingly attached to holes on upper part of the combustion wall;
fuel valve is a push to open valve operated by solenoid coils mounted on the valve gasket so that upper hole in the combust wall works as valve seat;
solenoid coils on rear side of fuel valve is connected to battery;
spark plug is mounted horizontally on the lower side of front part of rotor seal casing and opens inside the ignition chamber through a hole on upper part of the combustion wall so that its electrode is exposed towards the nozzle in the ignition chamber;
spark plug at its rear side is connected to ignition coil.

9. Flywheel, claimed in [claim 1], an externally teethed circular annular gear that functions as an output of the engine, is connected coaxially to the front side extension of outer annular cylinder of ignition chamber.

10. Thrust vectored ignition chamber engine described above is an engine which can use petrol as fuel and in order to use diesel as a fuel we need to replace spark plug with pressure valve, ignition coil with fuel source, air-fuel valve with air valve.

11. According to one variation to above description, nozzle seal mentioned in [claim 1], which dynamically puts nozzle into closed or open phase, consists of three annular cylinders, namely shutter cavity, shutter and shutter stopper, coaxially mounted on outer side of outer cylinder of ignition chamber near nozzle and a push-pull solenoid actuator, wherein
shutter cavity is a special type of annular cylinder, whose front portion coaxially holds the outer annular cylinder of ignition chamber with the help of a ball bearing but the rear portion (which is facing nozzle) forms an annular cylindrical cavity with outer annular cylinder of ignition chamber which can house shutter;
shutter is an annular cylinder coaxially mounted to the rear portion of the shutter cavity such that outer annular cylinder of ignition chamber slip fits inside the shutter and shutter can be operated by actuator to slide in and out of cylindrical annular cavity on the rear portion of shutter cavity to unseal and seal the nozzles respectively;
shutter stopper is an annular cylinder located on the rear side of nozzles, which coaxially holds the outer annular cylinder of ignition chamber, via one or more coaxial ball bearings and to helps to stop shutter from sliding away;
push-pull actuator consists of three-four solenoid coils mounted on the outer side of shutter cavity, which operates the shutter and works to push and pull the shutter to slide in and slide out of the cylindrical annular cavity on the rear portion of shutter cavity;
push-pull actuator is timed in a way that it put the nozzle in open state only at the end of ignition phase when compressed fuel gas is ignited and raised to a sufficient pressure to cause considerable rotary thrust upon exit through nozzle and put the nozzle in closed state after the ignited gas has exited through nozzle;
shutter cavity, and shutter stopper are secured to engine enclosure by rectangular slabs.

12. According to another variation to above description, thrust vectoring nozzle consists of pair of curved conical tubes so that escape angle of gas at outer surface of outer annular cylinder of ignition chamber can be closer to tangent of circle described by nozzles with aperture of nozzles inside the inner annular cylinder of ignition chamber, is along radial direction.
